(19) United States
(12) Patent Application Publication
(10) Pub. No.: US 2023/0132143 A1
(43) Pub. Date: Apr. 27, 2023

(54) SYSTEM, METHOD, OR APPARATUS FOR EFFICIENT OPERATIONS OF CONVERSATIONAL INTERACTIONS

(71) Applicant: Vocodia Holdings Corporation, Boca Raton, FL (US)

(72) Inventors: James V. SPOSATO, Boca Raton, FL (US); Brian PODOLAK, Boca Raton, FL (US)

(21) Appl. No.: 17/975,264

(22) Filed: Oct. 27, 2022

Related U.S. Application Data
(60) Provisional application No. 63/272,396, filed on Oct. 27, 2021.

(51) Int. Cl. H04M 3/493; H04M 3/523; H04M 3/51; G06F 40/40; G10L 15/26

(52) U.S. Cl. CPC H04M 3/4936; H04M 3/5232; H04M 3/5237; H04M 3/5175; G06F 40/40; G10L 15/26; H04M 2203/558

(57) ABSTRACT

The present disclosure can include a system, method, or platform for automated call management utilizing a switch capable being utilized with signals from a communication device. The switch interfaces with an artificial intelligence engine that provides contextual interactions to the switch. One or more databases of playback assets may be utilized to send the playback messages to the communications device. Middleware may provide analysis of data coming into the switch along with a call engine for configuring one or more calls made through the switch. Each call can include a call detail record (CDR) which is updateable with information regarding the calls.

### CROSS-REFERENCE TO RELATED APPLICATIONS

This application claims the benefit of provisional U.S. Application No. 63/272,396 entitled “Artificial Intelligence Conversation Engine for Telephony-Based Sales” filed Oct. 27, 2021, the technical disclosure of which is incorporated herein by reference in its entirety.

### BACKGROUND

### Technical Field

The present disclosure relates to systems, methods, and/or apparatuses for transitioning telephony-based conversational sales and servicing interactions. More particularly, and not by way of limitation, the present disclosure is directed to a system, apparatus, or method for transitioning telephony-based conversational sales and servicing interactions to and from an artificial intelligence engine, with decision processing, recording, and distribution completing a listen and response cycle in under 10 milliseconds.

### Description of Related Art

Most organizational communication to consumption base or constituency systems are driven by controlled agenda-based messaging, with most effective being conversational communications to convey ideas, exchange ideas and understand market desires, individually and grossly and generally. Since most conversations are agenda driven, they are scripted for control of conversation to improve effectiveness in meeting agenda (sales or influence), compliance (regulatory restrictions), interaction limitations (brand protection, consumer protection).

The system intentions are to improve the messaging via conversations over telephony (voice and text based), which improve on the efficiency of the organization to minimize the need for cost based controls to design, employ, manage and control humans, including associated real estate, equipment, human resourcing, training, maintenance, compliance (preparation, management and reporting and archiving), to achieve similar results as sales and consumer awareness, and support, with more efficiency by deployment of digital intelligent sales agents.

It would be advantageous to have a system and method for conversational interactions and/or automated call management that overcomes the disadvantages of the prior art. The present disclosure provides such a system and method.

### BRIEF SUMMARY

The present disclosure is a system for automated call management utilizing a switch capable of receiving signals from one or more communication devices. Where the switch interfaces with an artificial intelligence engine to provide contextual interactions for the switch to send to the one or more communication devices. The switch or the artificial intelligence engine can access one or more databases containing a set of playback assets. A set of middleware capable of providing analysis or processing of data coming into the switch may be utilized along with a call engine for configuring one or more calls made through the switch.

Thus, in one aspect, the present disclosure is directed to a platform for automated call management utilizing a switch capable of receiving signals from one or more communication devices. Where the switch interfaces with an artificial intelligence engine to provide contextual interactions for the switch to send to the one or more communication devices. The switch or the artificial intelligence engine can access one or more databases containing a set of playback assets. A set of middleware capable of providing analysis or processing of data coming into the switch may be utilized along with a call engine for configuring one or more calls made through the switch.

In another aspect, the present disclosure is directed to a method for automated call management. The method can identify a call as outgoing or incoming, where a switch and DISA engine are alerted that a call is ongoing. The switch can activate a set of ports in response to the alert allowing the call to be passed to the DISA engine by the switch. The call can be recorded through both audio and text. Each call can include a call detail record (CDR) and waiting for webhooks with a call engine. The webhooks allow for a connection of a telephony carrier, and allow the retrieved one or more playback assets with the DISA engine by the switch which are connected to the telephone carrier with the switch through a set of middleware. The individual or voicemail can be listened for and then upon speech detection the one or more playback asset can be initiated where the speech is passed to the DISA engine. The speech can be analyzed by the DISA engine via a natural language processing and allowing it to select a second set of playback assets.

Other aspects, embodiments and features of the present disclosure will become apparent from the following detailed description, when considered in conjunction with the accompanying figures. In the figures, each identical, or substantially similar component that is illustrated in various figures is represented by a single numeral or notation. For purposes of clarity, not every component is labeled in every figure. Nor is every component of the disclosure shown where illustration is not necessary to allow those of ordinary skill in the art to understand the disclosure.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a block diagram view of the automated call management system.

FIG. 2 is a process illustration of the method for automated call management.

FIG. 3 is a block diagram view of the automated call management system.

FIG. 4 is a signal flow diagram of an automated call management system.

FIG. 5 is a block diagram view of an automated call management system.

### DETAILED DESCRIPTION

Embodiments of the disclosure will now be described. The Vocodia AI System is a complete ecosystem for delivery of equal conversation between machine and person driven by the use of artificial intelligence, augmented intelligence, augmented reality, machine learning and neural linguistic programming exchanging intelligent dialogue over multiple mediums. In at least one example, the primary medium may be telephonic in nature but not limited to telephony. The system and method may allow for voice or data communications over one or more communication networks configured to utilize APNS/GCM/FCM or similar packet-based communication protocols. Some examples, may utilize portions of non-packet-based communication networks. In at least one example, to transmit and/or communicate over one or more communication networks, an authentication or token system may be utilized to allow for transmission and/or signals to be transmitted.

To allow for the function of conducting productive conversations with people or other conversational dependent machine based communication, a replacing of humans in the capacity and function of interactive conversations related to sales, customer service, presentations, notifications, surveys, surveillance, awareness, service announcements (public and private), and personal messaging between two or more individuals for agenda and purposed missions of companies, organizations, governments, municipalities and individuals all aspects of the system must operate in as close to real time as possible. Meaning speed is critical, if even a millisecond (ms) can be saved in computing and/or processing time, the conversations can be more life or human like in representation. A human voice reaction time to an auditory signal can be as low as 8 milliseconds (ms), meaning anything that is significantly longer than that can cause a delay that is noticeable to the individual on the line. If it appears there are long pauses that are from processing, there is more likelihood that an individual will disconnect the call because they think there is a robot or computer making the call. Accordingly, a goal of the present disclosure is to minimize the delay between the detection of an individual talking or when the individual has stopped talking.

Some examples of how processing apparatuses and/or systems might replace human sales agents and vary conversational necessitated presentations and investigations of individual prospective qualifications in both regulated and non-regulated environments, public service announcements, corporate intelligence gathering, and surveys. The systems and apparatus can provide the ability to analyze conversations for determining intent, which allows for intelligent response to inquiries in milliseconds, and when combined with ordered, agenda-based protocol or rules to drive conversations to a productive conclusion. For each respective software engagement by organizations for and between unlimited productive conversations with each and every individual in their consumer base, customer base or constituency, or potential thereof.

Systems for transitioning telephony-based conversational sales and servicing interactions to and from an artificial intelligence engine, with decision processing, recording, and distribution completing a listen and response cycle in under 10 milliseconds. The system can create a unique, fully dynamic voice driven, conversational exchange between human and machine by way of a controlled conversational artificial intelligence engine and may connect with external telephonic systems to complete telephony connection to the system. The system may also connect the conversational artificial intelligence engine to data or telephonic systems for action response to additional telephony or packet-based media providing dynamic conversational speech to human user over telephone, email, chat sessions, and social media, with full system processing occurring in milliseconds and processing controlled up to medium of exchange of telephony transfer.

The Vocodia system permits dynamic conversational exchange from a human (outside) through telephony (any, outside) to and from the system which controls a machine side of a conversation. Beginning with telephony system, the interactions with these telephone operations are operated by webhooks and API for exchange of transmission between system telephony (middleware) and outside telephony network (existing outside infrastructure). The process inside the Vocodia system permitting artificial intelligence conversation is processed by an artificial intelligence engine (DISA) serving the function of multiple processes transacting in milliseconds to function and/or produce the machine-side conversation. For example, initiating, connecting, or receiving calls, or other types of communications (including text based communications), listening to calls, listening, receiving voice transmission and text, driven by an Artificial intelligence engine, telephony switch, receiving voice transmission from outside consumer (human), determination of intent, accessing intent libraries for most appropriate response with NLP, processing response via neural voice or recording, and delivery of speech via system to middleware and voice emission over telephony. Sent to speech to text engine, and CDR updater for continuation of conversation and reporting of all statements on voice transmission or text in text-based transmission.

System Process

The desired, and/or designed entire round trip of conversational response from entry into the System is completed in 4 to 10 milliseconds. The time is affected by external telephony network, as some networks may have inherent delays due to bandwidth limitations or other hardware-initiated delays. The System begins with call detection identification. The call can be identified, as an inbound or outbound, with an alert activated and can be utilized independently of a call dialing or connection system. Logically, the alert can be a is there a call? Yes detected, or no undetected alert.

The artificial intelligence engine determines activity on a query basis reporting back a true/false response to the switch and the DISA engine. With a true response, the artificial intelligence engine begins activating the process and the artificial intelligence engine remains dormant if a false is reported. A “true” response (YES CALLER ACTIVE) sends signal to switch (Step 2).

When there is a true response, a response is sent to the Switch. The Switch activates telephony portal(s) for active communications between a customer on a phone and the system (DISA). In at least one example, a simultaneous with the switch's activation of telephone or other portal(s) there can be an activation of a demand to create a Call Detail Record, recording conversation in audio and text, and utilized to support decision function of DISA engine.

A Call Detail Record is created for each instance of an incoming or outgoing phone call. After the creation of the detail record which can include updating record fields, interaction details such as attitude, mood, intent, and/or other information that can be useful for the system as well as future users that may interact with an individual(s). There can also be updates from dynamic interaction between customer such as intent, key words, or other information. The DISA can continue to update the transactions of the instance of each record. While all of this is going on, the CDR can create alerts for the call engine.

The Call Engine waits for Webhooks before performing additional actions. For example, the Call engine waits for webhooks to connect the switch, via telephony carrier allowing for information and/or data to be supplied. Webhooks can by utilized to determine which playback assets or ‘speech recordings’, or neural voice reading of pre-set interactions (script) should be played and/or provided to the telephony carrier.

The Switch can contact the DISA to retrieve initial Playback Assets, simultaneously and/or before the call engine begins communications with the webhooks. Thus, the Switch activates the DISA engine to prepare to engage playback assets. These playback assets may in some examples, be preloaded based on an outgoing call, or based on the user's desired incoming message system.

The Switch makes Carrier connection (through middleware). Using this middleware, the Switch connects to outside carrier for the dial tone and answer. Alternatively, the outside carrier may be connected to for receiving a call.

The call engine and/or DISA, can listen for the first speech indications and record them for analysis and/or processing. Any Speech that is detected can activate assets that can be utilized for introductions in conversation, both for received speech or those instigated by a playback asset.

If a voicemail (VM) message is detected the additional assets or actions may be performed upon Detection. For example, if voicemail is detected, the system determines to discharge the instance or leave a playback asset at the tone. (campaign or user determined).

Playback Assets (initiate and continued), if VM, Disconnect, otherwise continue.

The call engine and/or DISA can listen for Speech. Upon live speech determination from customer side, pass speech to DISA engine, via text to speech. Upon passing to the DISA Text to speech converts to speech to text, to determine appropriate response by DISA, according to introductory playback assets prescribed. Using natural language processing (NLP), the DISA can process and/or analyze the Response options using predicted speech from customer side. Upon determination of a proper response, the appropriate playback of pre-recorded responses (playback assets, or written speech if neural voice), can be passed back to switch for voice transmission. During or shortly thereafter, a Call Detail Record (CDR) Update can be written.

The call engine can pass back to Switch. Voice messaging, response, statement, question, is passed back to switch based on information, analysis from the DISA.

Switch—Playback Assets are exchanged during the duration of Instance of interaction.

Determine Call action. Designated action of each instance is determined and activates conclusion of Instance of interaction. Transfer call or Hang up. CDR is updated and record completed.

Transaction Process is based on overlayer of protocol driving system in two functions:

Function for activating:

Webhooks Received

Pushed to Queue

Fan Out

Queue Record

Q Call State

Q Disposition

Q Recording

And function for repeating;
Process cycle repeat

Function protocols manage processes within two areas of the system, which operates independent of a single conversation as a human would initiate from dialing a phone, conversing, then hanging up. The system is fully operational initiating instances of consumer interaction with single human customers/prospects based on individual call detection. Dialing is managed by middleware and independent from the system.

Uses:

Primarily for replacement of salespeople and service agents to initiate telephone calls and text-based conversations autonomously and conduct agenda-driven telephone calls from structured data, then to persuade consumers to action beneficial for organizations and consumers. Agenda driven conversations are to be conducted at operator's desired scale of contact volume (quantity) with controls of volume adjustable and schedulable.

Other uses may include customer service-related functions, surveys, instructions, census, intelligence gathering, intelligence distribution, agency support, etc.

Vocodia System is capable of integration to existing SaaS applications such as CRM's, Internal databases, call center software, call systems carriers,

Most organizational communication to consumption base or constituency is driven by controlled agenda-based messaging, with most effective being conversational communications to convey ideas, exchange ideas, and understand market desires, individually, and grossly and generally. Since most conversations are agenda driven, they are scripted for control of conversation to improve effectiveness in meeting agenda (sales or influence), compliance (regulatory restrictions), interaction limitations (brand protection, consumer protection). Vocodia has created a system to offer a commercial solution to replace human salespeople with machine conversational artificial intelligence and augmented intelligence.

The system intentions are to improve the messaging via conversations over telephony (voice and text based), which improve on the efficiency of the organization to minimize the need for cost based controls to design, employ, manage and control humans, including associated real estate, equipment, human resourcing, training, maintenance, compliance (preparation, management and reporting and archiving), to achieve similar results as sales and consumer awareness, and support, with more efficiency by deployment of digital intelligent sales agents.

The system of the present disclosure is a complete ecosystem of delivery of equal conversation between machine and person with driven by the use of artificial intelligence, augmented intelligence, augmented reality, machine learning and neural linguistic programming exchanging intelligent dialogue over multiple mediums, with primary medium being telephonic in nature but not limited to telephony, in the function of conducting productive conversations with people or other conversational dependent machine based communication, replacing humans in the capacity and function of interactive conversations related to sales, customer service, presentations, notifications, surveys, surveillance, awareness, service announcements (public and private) and personal messaging between two or more individuals for agenda and purposed missions of companies, organizations, governments, municipalities and individuals. Current uses include replacing human sales agents for varying conversational necessitated presentations and investigations of individual prospective qualifications in regulated and non-regulated environments, public service announcements, corporate intelligence gathering and surveys. At present the system is capable conversations determining intent, allowing for intelligent response to inquiries in milliseconds, with ordered, agenda-based protocol to drive conversations to a productive conclusion for each respective software engagement by organizations for and between unlimited productive conversations with each and every individual in their consumer base, customer base or constituency, or potential thereof.

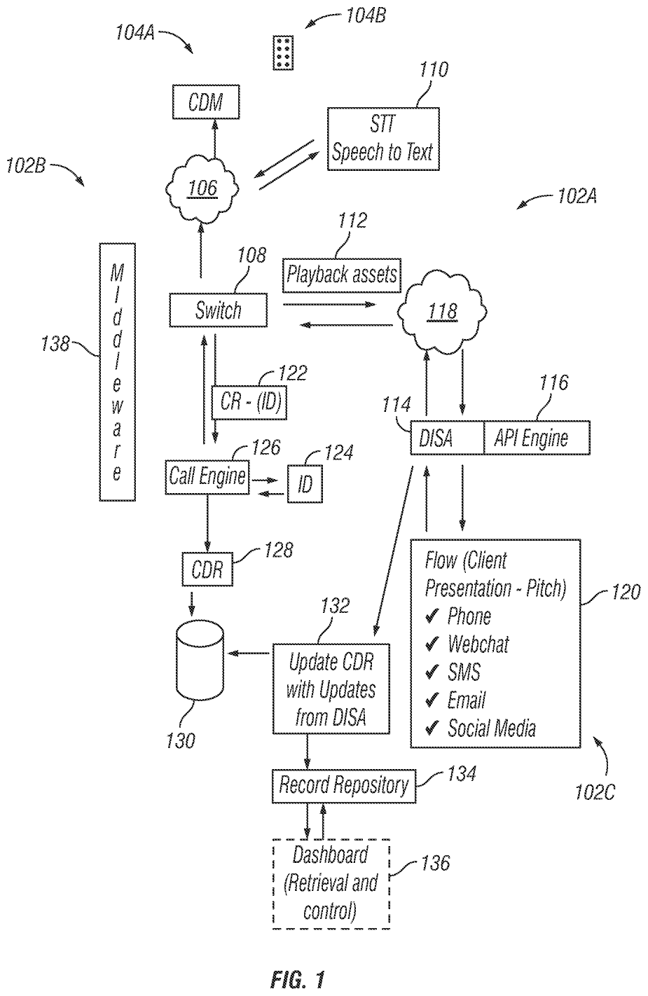

FIG. 1 is a block diagram view of the automated call management system 100. In at least one example, the system 100 can have three sections, a telephone and/or communications section 102A, a middleware section 102B, and an intelligence section 102C. The telephone and/or communication section 102A can include one or more devices (collectively devices 104). A network 106 may be utilized to connect the device(s) 104 to a switch 108 and/or a speech to text engine 110. The speech to text engine 110 can allow for the system 100 to process any speech coming from the devices 104 into text, which can be analyzed and/or processed in an efficient manner.

The switch 108 can interact with one or more databases that allow for playback assets 112 to be retrieved and/or received. These playback assets 112 may be received from the DISA 114 and/or API Engine 116 through a network 118. The DISA 114 is the heart of the automated call management system 100. The DISA 114 is an AI engine that allows for information to be analyzed, processed, queued, and/or updated with relative speed. The DISA 114 can include and/or interact with an API engine 116. This allows the DISA 114 to receive information, data, analysis, and/or processing from other computing devices, databases, and/or networks. The DISA 114 can work with a flow or presentation system 120 that allows for interactions with an individual, customer, user, caller, and/or called individual to be scripted and/or allow for decision trees to be created for various interactions, engagements, emotions, responses, and/or actions of an individual. The presentation system 120 can allow for phone engagement, webchats, SMS, email, social media, and/or other messaging services. In at least one example, the presentation system 120 may allow for playback assets to be queued, processed, and/or interactions to be preprogramed for particular responses. This can allow for additional reductions in response times.

The switch 108 can interact and/or create a call record 122. In some examples, the call record 122 may be linted with a call ID that allows for information related to the individual and/or business to be stored in one or more databases. The call record 122, and/or call ID 124, may be utilized by a call engine 126 to control the call engagement process. For example, the call engine 126 can initiate a call and/or call record for future call activities. It would be understood that calls may be interchanged with other messaging or communications platforms or systems. The call engine 126 may also interact with call detail record 128 that allow for details of each call, interaction, and/or action or response. These records can be stored in one or more databases 130. The DISA 114 may engage with the databases 130, with updates and/or update systems 132. These updates may occur with various information, queuing information or data, inflection or emotional state information or date, etc. A record repository 134 may be connected and/or coupled to the one or more database 130 to allow for updated data files to be stored and/or pulled from to create updates. A dashboard system and/or informational display 136 may be utilized to provide information and/or data to users for decision making purposes. Middleware 138 may be utilized at any point of the system to allow for quicker and/or better processing, analysis, and/or interactions.

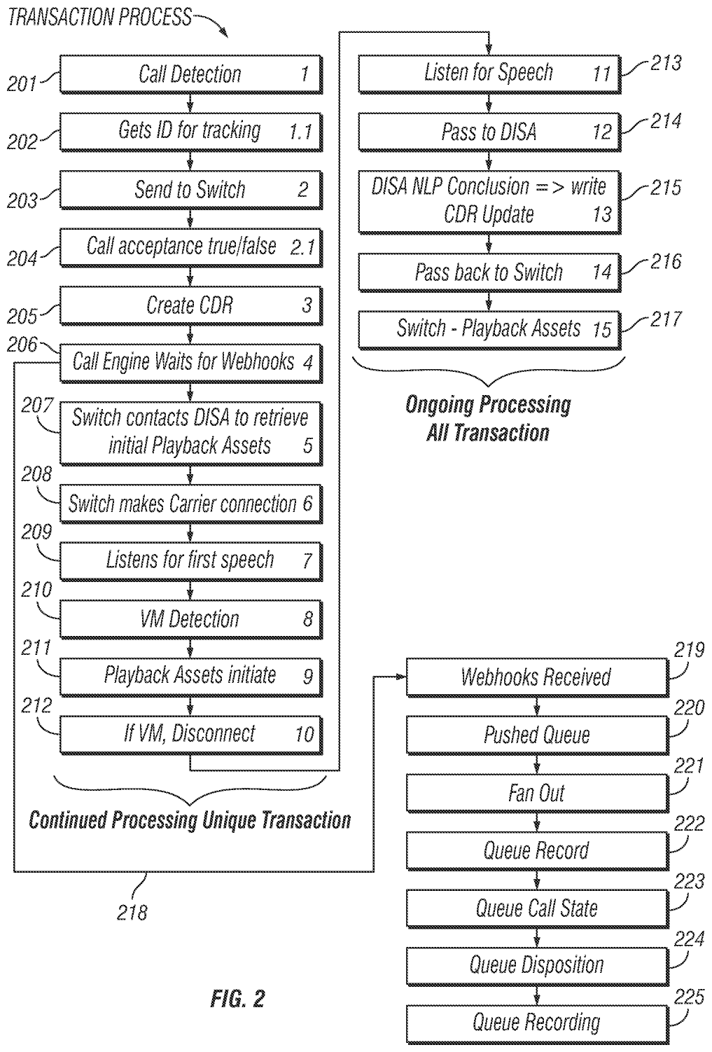

FIG. 2 is a process illustration of the method for automated call management 200. For example, process 1 can be call detection (201). The call detection may be done by any number of services and/or processors. In at least one example, there may be a call detection system for monitoring incoming phone lines or carrier to determine when an incoming call may be coming into the system and/or client customer. In other examples, call detection may be initiated when an outgoing call is scheduled and/or provided by a client or customer call or engagement system. Some examples of a call or engagement system could be a Customer Relationship Management (CRM) or a sales management program.

In process 1.1, the call, which can be an outgoing to incoming call, is given a call ID that allows it to be tracked throughout the system (202). The call ID can be used to preset the particular playback features or assets that will be available for the call. In some examples, the call ID may also include a set of tags that allow for playback assets to be gathered for particular types of calls. For example, a survey call will likely have a decision tree set of playback assets that are pared down after a response is received, whereas a sales call will likely have a set script that is not deviated from without significant feedback or responses. In at least one example, the call ID can be assigned concurrently with the call detection, or just shortly thereafter.

In process 2, the call and/or the call ID can be provided to the switch (203). The switch is a two-way device that allows for the playback assets to be delivered to the call, while also communicating with the call engine to allow for identification and updates to the call detection record. The call detection record, may be updated at each stage of the conversation as playback assets are utilized and/or prepared for use. For example, multiple playback assets can be prepared for use depending on t. specific responses received from the person called or the person making the call to the system. Some examples of the playback assets may include those for a negative, neutral, or positive response.

In process 2.1, the call can be monitored for acceptance in a true/false test (204). For example, if the call is answered by an individual then the call has been accepted. If the call rolls to a voicemail message, it will depend on the customer, user, or client if any messages are left for the individual called. However, this would be considered a false response on the call acceptance decision analysis. The call acceptance analysis is an important decision as it can drive most if not all of the other decisions in a call record.

Process 3, can be the creation of the call detail record (also referenced as CDR) (205). The call detail record is the data record for everything dealing with a call. In some examples, the call detail record can be preloaded with a decision tree with playback assets for each junction of the decision tree. For example, a playback asset may be assigned for when an option for leaving a voicemail is provided. Similarly, there may be an after-answer playback asset that can begin the decision tree.

In process 4, the call engine waits for webhooks (206). In at least one example, the call engine can be waiting for webhook messages to be received, while in other examples, the call engine is waiting to send webhook messages. In at least one embodiment, the call engine is capable of sending and receiving various webhook messages. These webhooks may be information regarding the individual called or the entity making the call. In other examples, there can be additional information such as addresses, billing information, and/or other information that may be useful for coordinating the calls or playback assets.

Process 5, can allow for the switch to contact the DISA to retrieve initial playback assets (207). In at least one example, a set of playback assets, where a set can be one or more, is retrieved from the DISA. The DISA is the heart of the system, it communicates all of the information for each asset to other portions of the systems.

The process 6, is the switch making a connection with the various carriers (208). For example, a Verizon, T-Mobile, or AT&T, and/or other networks as well.

In process 7, the Switch or DISA, depending on where and what part of the system is engaging first, may listing for the first speech from the called individual (209). The amount of time it takes for a playback asset to be accessed after detecting the first indication of an individual responding to the call can be the difference between the call continuing or being ended.

Process 8 is the monitoring and/or detection of a voicemail message (210). Depending on the caller's desire a playback asset can be played back as a voicemail message, or the call can be ended at the time the voicemail or voicemail box is detected.

In process 9, at least one playback asset is initiated (211). These playback assets may be of any length, ranging from 0.01 seconds to over 60 minutes each. These playback assets may also correspond to particular clients, or may have a general message that is provided by one or more voices or voice models. In at least one example, a voice may be generated based on text that is provided to via an AI engine, in some examples there may be different voicing styles such as male, female, British, Irish, German, Scottish, and/or other country accents.

A process 10, may allow for the call to be disconnected by the switch if a voicemail is detected (212). In at least one example, this process may skip in order to play a playback asset for the voicemail.

The process 11, the Switch can monitor a call to determine if there is speech from the individual called (213). In some examples, if it is known that the individual is a particular gender, ethnicity, and/or comes from a particular region the individual may be identified, and if that individual is not the one intended the call may be ended without continuing with the rest of the playback assets.

In process 12, the message can be passed to the DISA for processing (214). In at least one example, this processing may include reviewing the CDR for contextual information, which can be utilized with an AI, NLP, and/or ML program. For example, speech if recorded may be provided to an AI, NLP, and/or ML program to convert the recording to text for analysis of syntax, context, emotion levels, and/or state of mind of the individual whose speech was recorded.

In processes 13, the DISA receives the results of the AI, NLP, and/or ML program analysis and performs an update to the CDR (215). This allows information to be adjusted for future context or knowledge. For example, a caller may say they are night worker, which can allow the CDR and/or a CRM update to indicate not to call during the early morning or mid-day.

Following in process 14, the call, CDR, and/or recording is passed back to the switch in order to continue the conversation with the individual called or that called the system (216).

In process 15, the switch retrieves and plays specific playback assets (217). In at least one example, these playback assets are chosen based on the results of analysis by the AI, NLP, and/or ML program.

These processes may have a set order, or be done in a combination of serial and parallel operation. For example, processes 1-10 may operate in a serial or set order, while processes 11-15 are done in parallel for the majority of the calls. Further to this example, when webhooks are utilized, there may be a waiting period for a message to be received (219), a queue may be pushed, fanned out (221), recorded (222), and/or a caller or callee's state (223), deposition (224), or recording status may be utilized (225). A queue may be utilized for any portion of the processes, but in particular for the playback assets, as this is one way that time can be shortened for the response period which is critical for the system. Similarly, a fan out allows for multiple calls to be initiated while waiting for the webhooks, and in some examples, an algorithm is keeping track of the average or weighted average wait or response times from webhooks.

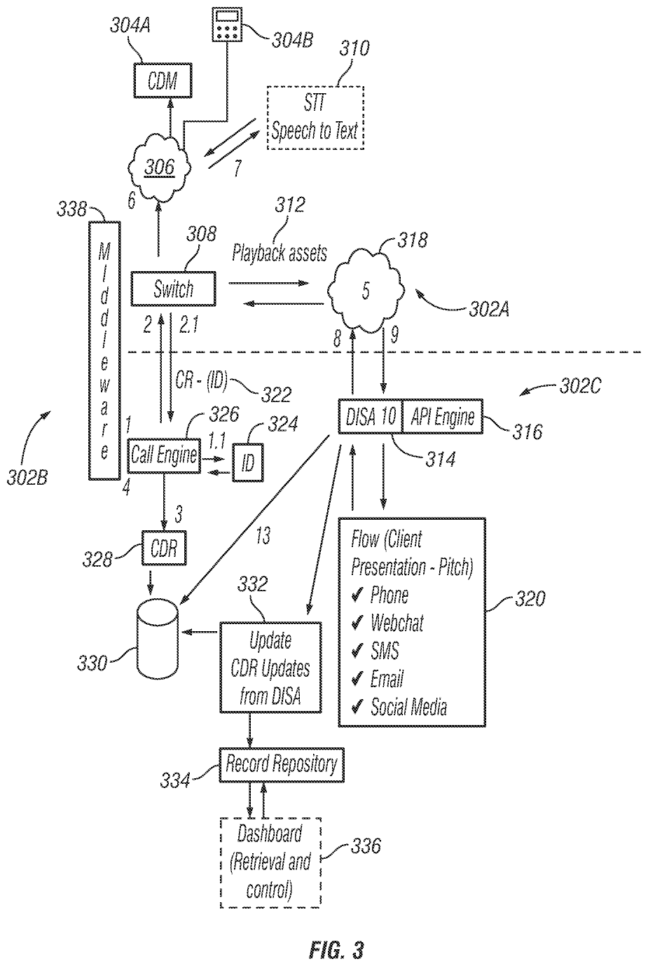

FIG. 3 is a block diagram view of the automated call management system 300. FIG. 3 may include references to FIG. 2 as shown, and are provided for illustration purposes. In at least one example, the system 300 can have three sections, a telephone and/or communications section 302A, a middleware section 302B, and and intelligence section 302C. The telephone and/or communication section 302A can include one or more devices (collectively devices 304). A network 306 may be utilized to connect the device(s) 304 to a switch 308 and/or a speech to text engine 310. The speech to text engine 310 can allow for the system 300 to process any speech coming from the devices 304 into text, which can be analyzed and/or processed in an efficient manner.

In some examples, call detection may occur in the communications section 302A, and/or the middleware section 302B, with the assistance of the intelligence section 302C. The call detection may be done by any number of services and/or processors. In at least one example, there may be a call detection system for monitoring incoming phone lines or carrier to determine when an incoming call may be coming into the system and/or client customer. In other examples, call detection may be initiated when an outgoing call is scheduled and/or provided by a client or customer call, or engagement system. Some examples of a call or engagement system could be a Customer Relationship Management (CRM) or a sales management program.

The switch 308 can interact with one or more databases that allow for playback assets 312 to be retrieved and/or received. The switch 308 is a two-way device that allows for the playback assets to be delivered to the call, while also communicating with the call engine to allow for identification and updates to the call detection record. The call detection record, may be updated at each stage of the conversation as playback assets are utilized and/or prepared for use. For example, multiple playback assets can be prepared for use depending on the specific responses received from the person called or the person making the call to the system. Some examples of the playback assets may include those for a negative, neutral, or positive response.

The call detail record is the data record for everything dealing with a call. In some examples, the call detail record can be preloaded with a decision tree with playback assets for each junction of the decision tree. For example, a playback asset may be assigned for when an option for leaving a voicemail is provided. Similarly, there may be an after-answer playback asset that can begin the decision tree. The switch 308 making a connection with the various carriers (208). For example, a Verizon, T-Mobile, or AT&T, and/or other networks as well.

These playback assets 312 may be received from the DISA 314 and/or API Engine 316 through a network 318. The DISA 314 is the heart of the automated call management system 300. The DISA 314 is an AI engine that allows for information to be analyzed, processed, queued, and/or updated with relative speed. The DISA 314 can include and/or interact with an API engine 316. This allows the DISA 314 to receive information, data, analysis, and/or processing from other computing devices, databases, and/or networks. The DISA 314 can work with a flow or presentation system 320 that allows for interactions with an individual, customer, user, caller, and/or called individual to be scripted and/or allow for decision trees to be created for various interactions, engagements, emotions, responses, and/or actions of an individual. The amount of time it takes for a playback asset to be accessed after detecting the first indication of an individual responding to the call can be the difference between the call continuing or being ended. Depending on the caller's desire a playback asset can be played back as a voicemail message, or the call can be ended at the time the voicemail or voicemail box is detected. These playback assets may be of any length, ranging from 0.01 seconds to over 60 minutes each. These playback assets may also correspond to particular clients, or may have a general message that is provided by one or more voices or voice models. In at least one example, a voice may be generated based on text that is provided to via an AI engine, in some examples there may be different voicing styles such as male, female, British, Irish, German, Scottish, and/or other country accents. In at least one example, these playback assets are chosen based on the results of analysis by the AI, NLP, and/or ML program. A queue may be utilized for any portion of the processes, but in particular for the playback assets, as this is one way that time can be shortened for the response period which is critical for the system. Similarly, a fan out allows for multiple calls to be initiated while waiting for the webhooks, and in some examples, an algorithm is keeping track of the average or weighted average wait or response times from webhooks.

The presentation system 320 can allow for phone engagement, webchats, SMS, email, social media, and/or other messaging services. In at least one example, the presentation system 320 may allow for playback assets to be queued, processed, and/or interactions to be preprogramed for particular responses. This can allow for additional reductions in response times. In at least one example, a set of playback assets, where a set can be one or more, is retrieved from the DISA. The DISA is the heart of the system, it communicates all of the information for each asset to other portions of the systems.

The switch 308 can interact and/or create a call record 322. In some examples, the call record 322 may be linted with a call ID that allows for information related to the individual and/or business to be stored in one or more databases. The call record 322, and/or call ID 324, may be utilized by a call engine 326 to control the call engagement process. For example, the call engine 326 can initiate a call and/or call record for future call activities. It would be understood that calls may be interchanged with other messaging or communications platforms or systems. The call engine 326 may also interact with call detail record 328 that allow for details of each call, interaction, and/or action or response. These records can be stored in one or more databases 330.

In at least one example, the call engine can be waiting for webhook messages to be received, while in other examples, the call engine is waiting to send webhook messages. In at least one embodiment, the call engine is capable of sending and receiving various webhook messages. These webhooks may be information regarding the individual called or the entity making the call. In other examples, there can be additional information such as addresses, billing information, and/or other information that may be useful for coordinating the calls or playback assets.

The DISA 314 may engage with the databases 330, with updates and/or update systems 332. These updates may occur with various information, queuing information or data, inflection or emotional state information or date, etc. A record repository 334 may be connected and/or coupled to the one or more database 330 to allow for updated data files to be stored and/or pulled from to create updates. A dashboard system and/or informational display 336 may be utilized to provide information and/or data to users for decision making purposes. Middleware 338 may be utilized at any point of the system to allow for quicker and/or better processing, analysis, and/or interactions.

The call ID can be used to preset the particular playback features or assets that will be available for the call. In some examples, the call ID may also include a set of tags that allow for playback assets to be gathered for particular types of calls. For example, a survey call will likely have a decision tree set of playback assets that are pared down after a response is received. Where a sales call will likely have a set script that is not deviated from without significant feedback or responses. In at least one example, the call ID can be assigned concurrently with the call detection, or just shortly thereafter. In some examples, if it is known that the individual is a particular gender, ethnicity, and/or comes from a particular region the individual may be identified and if that individual is not the one intended the call may be ended without continuing with the rest of the playback assets.

For example, if the call is answered by an individual then the call has been accepted. If the call rolls to a voicemail message, it will depend on the customer, user, or client if any messages are left for the individual called. However, this would be considered a false response on the call acceptance decision analysis. The call acceptance analysis is an important decision as it can drive most if not all of the other decisions in a call record. In at least one example, this processing may include reviewing the CDR for contextual information, which can be utilized with an AI, NLP, and/or ML program. For example, speech if recorded may be provided to an AI, NLP, and/or ML program to convert the recording to text for analysis of syntax, context, emotion levels, and/or state of mind of the individual whose speech was recorded. This allows information to be adjusted for future context or knowledge. For example, a caller may say they are night worker, which can allow the CDR and/or a CRM update to indicate not to call during the early morning or mid-day.

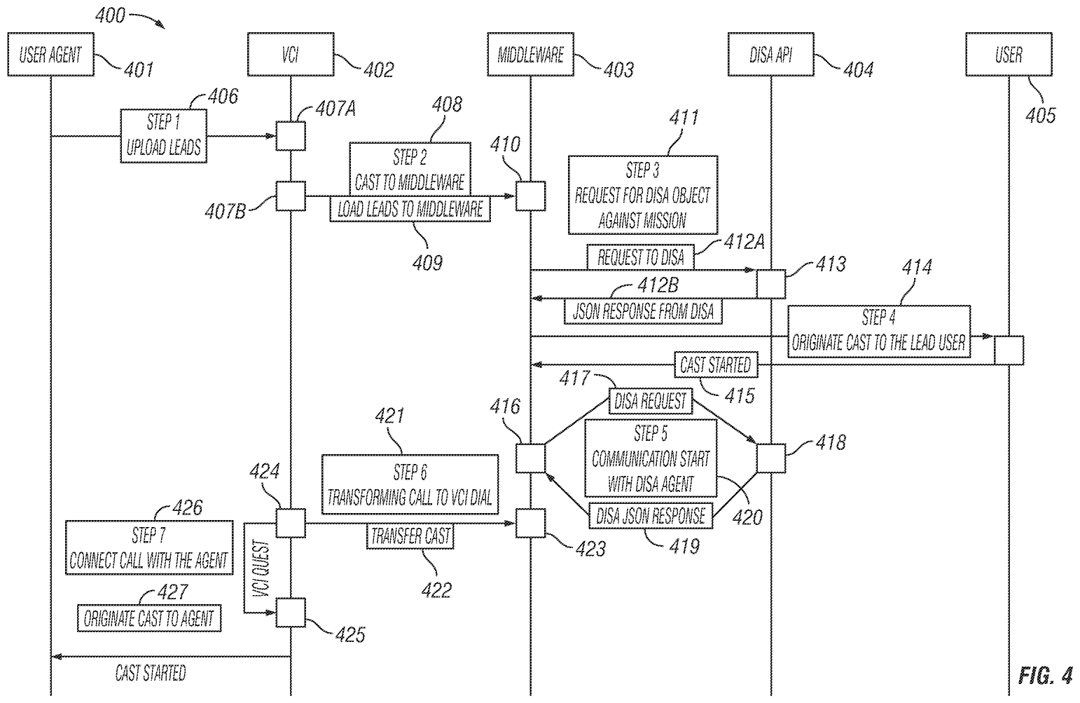

FIG. 4 is a signal flow diagram of an automated call management system 400. A user's agent 401 can be utilized to connect a user's information. In at least one example, the user's agent 401 may be a combination of hardware and software or either one individually. For example, the user's agent 401 may be a combination of hardware (a computing device) and software (executing and/or processed by the computing device) in a manner that allows for a transfer of information or data (a data set) between a set of computing devices.

A VCI 402 allows for voice controller operations and/or information to be cast and/or transmitted. In at least one example, the VCI 402 can cast (push to another data stream) or fan out (across multiple data streams) allowing for information to be pushed to each different avenues of information analysis or processing. In some examples, the VCI 402 can process and/or transform information to be a different call type (standard dial tone call or voice of internet protocol).

Middleware 403 may be programs and/or hardware that allows for calls to be processed, analyzed, and/or converted into different file types. One example of middleware would be a system, software and/or hardware that will allow for the speech-to-text and/or audio to be analyzed for inflection and/or tone of conversation. This type of analysis can provide information that the automated call management system 400 can utilize to move a conversation forward or toward a reasonable conclusion. Other similar non-exhaustive examples of analysis that may be utilized, various speech, audio, video, text, and/or other types of analysis or processing programs may be utilized. In some examples, a system may be utilized to determine if the called number is being operated by a robot and/or computer. A DISA API 404 can be utilized as an application programing interface, or may be a directly accessed program, and/or hardware interaction. The DISA 404 can be an artificial intelligence (AI) engine that performs to deep analysis and/or creation of content for the automated call management system 400.

A user 405 can be the central focus of the automated call management system 400. For example, it is the user 405 that activates and/or engages the automated call management system 400 to allow for calls to be made. The user 405 may at times monitor the activities and/or engagement of the automated call management system 400.

Step 1 (406), the user agent 401 can provide and/or upload leads to the VCI 402.

The VCI 402 can process and/or analyze 407A the leads before passing them to middleware 403. In some examples, the VIC 402 may prepare and/or transform 407B the leads in preparation for transferring the leads to the middleware 403.

In Step 2 (408), the user agent 402 can cast the leads to the middleware. In some examples, casting may include sending and/or processing leads in batches or a complete transfer. Casting is often referred to as the passing of information from one device to another, while the primary signal and/or processing of information is done on the first device.

In alternative step 2 (409), the user agent 402 can load the leads into the middleware 403.

The middleware 403, can perform analysis, processing and/or otherwise transform the leads and/or other data provided to the middleware 403 as part of step 410.

In step 3 (411), the middleware 403 can request a DISA object that is in agreement or against a particular mission. If the request is in agreement, then the processing and/or analysis of the request can begin. However, if the request is against the mission (for example, there is a data mismatch or an unknown request code or header), there may be a delay until the proper knowledge can be obtained. Similarly, if the request is known or agrees with a known request in the DISA 404 then there can be automatic response preparation through analysis, processing, and/or other operations. In some examples, the request to the DISA 412A may result in a JSON response from the DISA 412B.

For Step 4 (414), the middleware 403 can originate a cast of the lead to the user 405. In some examples, the cast will allow for information to be passed while processing remains with the middleware 403. In at least one example, the middleware 403 can provide data and/or other information to a user 405 for other use cases. For example, one use case may be for a CRM system and providing updates to a contact record of said CRM system. The user 405 may process and/or take action on the cast information 416, and then acknowledge that the cast has started 415. A cast may include multiple data sets and/or a stream of information that may occur over a few seconds, minutes, hours, days, months, and/or even years. In some examples, the origination of cast to the lead user 414, may be to initiate a cast of data or information to the middleware 403 from the user 405.

The middle ware 403 may initiate a process, task, or combination thereof 416 that causes a request 417 to be sent to the DISA 404. The DISA 404 may initiate a process, task, or combination there of 418 to complete the request 417. A response from the DISA may be formatted as a JSON response 419, or other file or format types. These operations may be considered a step 5 (420) that allows for communications between the middleware 403 and DISA 404.

In step 6, a call can be transformed to a VCI (virtual channel identifier) dial 421. Part of this transformation may include transferring the cast 422. This transfer may occur between the middle ware 403 and the VCI 402. The middle ware 403, can perform many of the processes or steps 423 needed to affect the transfer of the cast or transforming the call to VCI dial. Similarly, the VCI 402 may perform operations, processes, or tasks related to transformation or transfer 424, or may make a request 425.

The step 7 (426) can include connecting the call with the agent 401, or originating the case to the gage 427. For example, if the call has been originated elsewhere, then the connection or casting may include additional operations or steps.

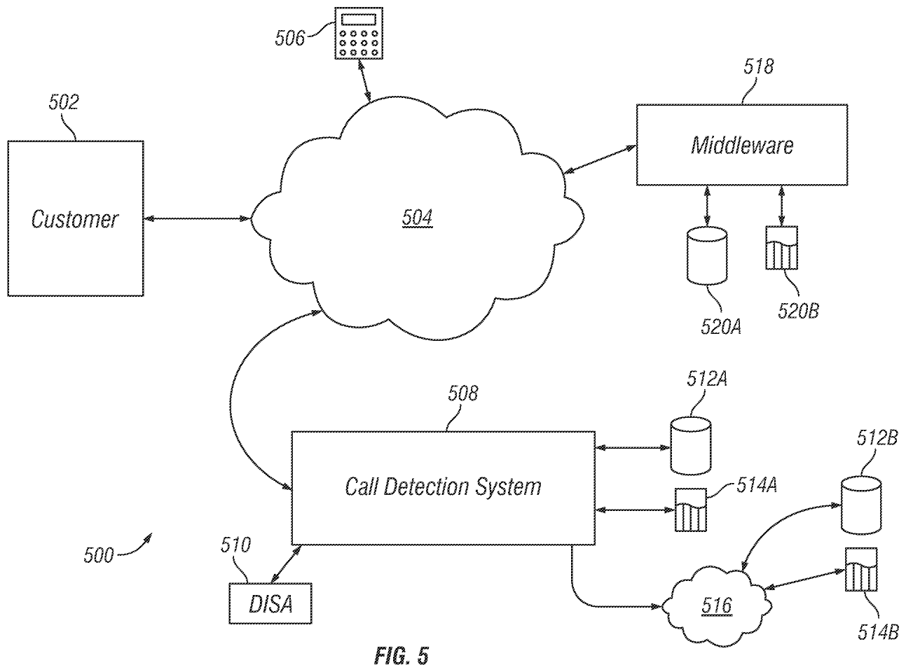

FIG. 5 is a block diagram view of an automated call management system 500. A user 502 may connect through a network 504. In at least one embodiment, the user 502 may be an individual operating a calling station at a call center. In other examples, the individual may be calling from any location capable of receiving a signal that allows for voice and/or data communications. These communications can be through a network 504 that may be a wired or wireless network that can allow for voice or data transmissions. A communications device 506, which may incorporate a computing device, processor, and/or controller may also connect to the network 504. In some examples, the communications device 506 may be utilized by the customer or user 502.

A call detection system 508 can be utilized to monitor specific call channels for various activities, while in other examples the call detection system 508 may be utilized by a call center to monitor voice or data channels for activity from a caller or someone called. While monitoring outbound calls from a call center, placed by a user 502 using a communication device 506. In some examples, the call detection system 508 may utilize a DISA 510 or other artificial intelligence engines to assist and/or process the monitoring or detection. The DISA 510 can be utilized to provide various assets for playback, analysis, processing, and/or reactions based on feedback, voice, and/or data provided. The DISA 510 and/or call detection system 508 may utilize multiple databases 512A/512B. Additional processors, computing devices, and/or other systems or devices for analysis 514A/514B can also be utilized by the DISA 510 and/or call detection system 508. In some examples, these databases 512A/512B and/or additional processors, computing devices, and/or other systems or devices for analysis 514A/514B may be coupled to the DISA 510 and/or call detection system 508 through an additional network 516 that may be secured, private, wired, and/or wireless. In other examples, additional network 516 may be a subset of network 506, or a supplement to network 506.

A middleware 518, which may be hardware, software, or a combination of both may be utilized to perform certain steps, processes, tasks, analysis, and/or operations of the call detection system 508 and/or DISA 510. The middleware 518 may interact with middleware databases 520A and/or middleware processors or computing devices 520B.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

We claim:

1. A system for automated call management comprising:
a switch capable of receiving signals from one or more communication devices;
an artificial intelligence engine for interfacing with the switch to provide contextual interactions for the switch to send to the one or more communication devices;
one or more databases for containing a set of playback assets that may be accessed by the switch or the artificial intelligence engine;
a set of middleware capable of providing analysis or processing of data coming into the switch; and
a call engine for configuring one or more calls made through the switch.

2. The system of claim 1, wherein the artificial intelligence engine can utilize natural language processing to determine a proper response to an individual's speech.

3. The system of claim 1, wherein the set of middleware includes one or more telephony carrier connections.

4. The system of claim 1, wherein the one or more communication devices includes a phone.

5. The system of claim 1, wherein the set of playback assets includes pre-scripted responses for common interactions with individuals.

6. The system of claim 1, further comprising a speech to text engine coupled to the switch.

7. The system of claim 6, wherein the artificial intelligence engine utilizes an output of the speech to text engine and audio provided from the switch for analysis.

8. The system of claim 1, wherein the call engine is capable of engaging the artificial intelligence engine to select and send one or more playback assets to the switch.

9. The system of claim 1, wherein the one or more databases can include the one or more playback assets; one or more scripts for customer interactions; and one or more call detail records.

10. A platform for automated call management comprising:
a switch capable of receiving signals from one or more communication devices over a network;
an artificial intelligence engine for interfacing with the switch to provide contextual interactions for the switch to send to the one or more communication devices;
one or more databases for containing a set of playback assets that may be accessed by the switch or the artificial intelligence engine;
a set of middleware capable of providing analysis or processing of data coming into the switch; and
a call engine for configuring one or more calls made through the switch.

11. The platform of claim 10, wherein the switch is a network connected device configured to analyze incoming or outgoing calls for transmission coordination with the one or more communication devices.

12. The platform of claim 10, wherein the artificial intelligence engine is operated as an application program interface (API) that interfaces with the switch over the network.

13. The platform of claim 10, wherein the artificial intelligence engine selects one or more playback assets from the set of playback assets for transmission to the one or more communications devices through the switch.

14. The platform of claim 10, wherein the middleware is accessed through the network.

15. The platform of claim 10, wherein the middleware can perform analysis for inflection based on speech or text.

16. The platform of claim 10, wherein the middleware can perform analysis for a tone of the communication based on speech or text.

17. The platform of claim 10, further comprising a speech to text engine.

18. The platform of claim 10, wherein the call engine interacts with the switch to initiate call responses or calls and routes them through the switch to appropriate numbers.

19. A method for automated call management comprising:
identifying a call as outgoing or incoming;
alerting a switch and a DISA engine that a call is ongoing;
activating a set of ports on the switch in response to the alert allowing the call to be passed to the DISA engine by the switch;
recording the call through both audio and text;
creating a call detail record (CDR) for each call;
waiting for webhooks with a call engine, wherein the webhooks allow for a connection of a telephony carrier;
retrieving one or more playback assets based on contact to the DISA engine by the switch, wherein the DISA engine prepares to engage the one or more playback assets;
connecting to the telephone carrier with the switch through a set of middleware; listening for an individual or voicemail;
initiating the one or more playback assets based on speech detection, wherein the speech is passed to the DISA engine;
analyzing the speech with the DISA engine via a natural language processing and selecting a second set of playback assets; and
passing the second set of playback assets to the switch for communication to the individual while updating the CDR with the interaction.

20. The method of claim 19, wherein the call detail record is updated dynamically based on caller interactions to the playback assets as provided based on the DISA engine.

21. The method of claim 19, wherein the call engine waits for webhooks to initiate the playback assets, or a reading based on a pre-set interaction script.
